(19) United States
(12) Patent Application Publication
(10) Pub. No.: US 2025/0077894 A1
(43) Pub. Date: Mar. 6, 2025

(54) CAPTURING A SCENE IN A MULTIMODAL FIELD

(71) Applicant: Robert Bosch GmbH, Stuttgart (DE)

(72) Inventor: Andre Wagner, Hannover (DE)

(21) Appl. No.: 18/817,295

(22) Filed: Aug. 28, 2024

(30) Foreign Application Priority Data
Sep. 6, 2023 (DE) 10 2023 208 615.8

(51) Int. Cl. G06N 3/0985; G01S 13/88; G06T 7/00; G06T 7/90; G06V 20/56

(52) U.S. Cl. CPC G06N 3/0985; G01S 13/881; G06T 7/90; G06T 7/97; G06V 20/56

(57) ABSTRACT

A method for training a neural network, which, based on coordinates of a location in a scene and information about a perspective from which the location is viewed, predicts color information long with values of at least one further physical measured variable that relate to this location. The method includes: capturing both camera images of the scene and values of the further physical measured variable as training examples from a plurality of perspectives; supplying coordinates of locations at which color information and/or values of the at least one further physical measured variable can be captured from every perspective, together with information characterizing the perspective, to the neural network; evaluating using a predetermined cost function.

### CROSS REFERENCE

The present application claims the benefit under 35 U.S.C. § 119 of German Patent Application No. DE 10 2023 208 615.8 filed on Sep. 6, 2024, which is expressly incorporated herein by reference in its entirety.

### FIELD

The present invention relates to the creation of representations of scenes observed, for example, from a vehicle or robot.

### BACKGROUND INFORMATION

The at least partially automated driving of vehicles and/or robots on company premises or in public transport requires continuous monitoring of the environment of the vehicle and/or robot. In addition to cameras, further sensors with other measurement modalities, such as radar or lidar, are also used for this purpose at the same time. The different measurement modalities complement one another. In particular, this ensures that environmental monitoring is seamless even if one of the measurement modalities is not functioning at the time.

For example, if the low sun hits the lens of a camera, at least part of the image may burn out because certain image pixels are saturated in intensity. A radar sensor is not influenced by this and still provides, for example, the important information that another vehicle or other object is located at a certain location in the vehicle environment. However, the image information in the burned-out region is still lost.

### SUMMARY

The present invention provides a method for training a neural network. According to an example embodiment of the present invention, on the basis of the coordinates of a location in a scene and information about a perspective from which the location is viewed, this neural network predicts color information along with values of at least one further physical measured variable. In particular, the color information can, for example, indicate which light color the material located at the corresponding location emits when it is irradiated with white light. However, the color information can, for example, also indicate which light color is emitted by a self-luminous object, such as a lamp, located at the corresponding location.

As part of the method, both camera images and values of the further physical measured variable are captured as training examples from a plurality of perspectives. For these perspectives, coordinates of locations at which color information and/or values of the at least one further physical measured variable can be captured from the particular perspective are then supplied, together with information characterizing the perspective, to the neural network to be trained.

These locations may not only be locations that are in a direct line of sight from the current perspective. In fact, radar beams can, for example, also penetrate objects or obstacles and provide information from locations that are not currently visible.

The perspective can, for example, in particular be characterized by angles at which the location is viewed and/or by a viewpoint from which the location is viewed. For example, in a complex scene, the view of a particular location from a particular direction may be clear from a viewpoint at a short distance. From a viewpoint at a greater distance, however, the view of the location may be obscured (occluded) by another object, such as a tree, another vehicle or people.

In response to said input, the neural network provides color information and/or values of the at least one further physical measured variable. A predetermined cost function is used to evaluate the extent to which this color information or these values are consistent with the camera images actually captured from the particular perspective, and/or values of the at least one further measured variable. Parameters that characterize the behavior of the neural network are optimized with the aim of improving the evaluation by the cost function in the further processing of coordinates of locations and perspectives.

It has been recognized that the neural network can be enabled in this way to generate a multimodal representation of the scene, which provides, even for unseen combinations of queried locations and perspectives, color information and/or values of the at least one further measured variable that the particular location of this perspective offers. In particular, the various measurement modalities can complement one another such that gaps in the capture of the scene by one measurement modality can be filled on the basis of the information obtained with other measurement modalities.

The training is self-supervised. It does not rely on the measurement data being labeled in any way with the target outputs of the neural network. Instead, the training only works with measurement data that can be captured in an automated manner.

In the example mentioned, in which the low sun burns out part of a camera image, the radar measurements can, for example, be used to estimate how the burned-out part of the camera image is to be reconstructed on the basis of its surrounding area.

Even if all imaging modalities function perfectly, they can complement one another well. For example, radar data can be used to predict how an object that is only partially visible in the camera image continues in the region that is no longer visible.

Conversely, radar measurements, which have a comparatively poor spatial resolution, can, for example, also benefit from the high spatial resolution of camera images. For example, values of the measured variables provided by the radar can be provided by the neural network with a higher spatial resolution than the radar measurement can provide on its own. At the same time, the information that especially the radar measurement can provide particularly well is retained, such as the material of a captured object or a velocity relative to this object.

The fully trained neural network thus functions in a way analogous to a diorama, in which a scene is constructed from three-dimensional figures, buildings and other objects: Points in the three-dimensional space are assigned both color information and values of the at least one further physical measured variable. Any view from any perspective can be generated therefrom. The neural network can be used in an analogous manner to neural radiance fields, which predict only color information and, optionally, also an optical density for a location and a perspective. However, as explained above, this benefit does not stop at the boundaries between measurement modalities.

According to an example embodiment of the present invention, the training takes place anew for each scene. The ability of the neural network to generalize to the unseen is thus used here not in relation to unseen scenes, but in relation to unseen perspectives. In this respect, it is also unproblematic that the neural network trained specifically for a scene is massively overfitted for this scene.

An important application of this capability is the behavior planning of vehicles and/or robots, which rely on continuous environmental monitoring. Systems for such behavior planning must be tested with views from a plurality of perspectives, which cannot even all be physically measured. In a particularly advantageous embodiment, the trained neural network is therefore supplied with at least one combination of a location and a perspective that was not seen during training. The color information subsequently provided by the neural network along with values of at least one further physical measured variable and/or a processing product formed from these variables are supplied to at least one system for the behavior planning of a vehicle and/or robot.

The output of this behavior planning system is compared to an expected output. Such an expected output can, for example, in particular be derived from the known scene. This is because the scene itself does not change, but only new views of the same scene are generated.

The result of the comparison is used to evaluate whether the behavior planning system is functioning properly. This function test can then be carried out with many more perspectives than if the scene had to be physically viewed from each perspective.

A further important application is simulating how a change in the configuration of cameras and/or further sensors affects the function of downstream systems.

In a further, particularly advantageous embodiment of the present invention, the trained neural network is therefore supplied with at least one combination of a location and a perspective that was not seen during training and that represents a different configuration of cameras and/or further sensors than the one used to capture the training examples. The color information subsequently provided by the neural network along with values of at least one further physical measured variable and/or a processing product formed from these variables are supplied to at least one downstream system.

The resulting behavior of the downstream system is compared to an expected behavior. The result of this comparison is used to evaluate whether the combination of the new configuration of cameras and/or further sensors with the downstream system is functioning properly.

For example, cameras and other sensors have to be mounted in different locations on each new vehicle type, because each new vehicle type has slightly different dimensions. If a scene has been driven through with one vehicle type, those views of the same scene that is generated by the cameras and other sensors on another vehicle can be simulated. Without having to record new data, it can then be checked whether, for example, the environmental monitoring and trajectory planning used for the previous vehicle type can continue to be used as is on the new vehicle type. If this is not the case, the configuration of the cameras and/or further sensors, and/or the downstream environmental monitoring and trajectory planning, must be modified.

In a further, particularly advantageous embodiment of the present invention, the configuration of cameras and/or further sensors is thus optimized for a predetermined optimization goal. This optimization goal can, for example, in particular include improving the consistency of the behavior of the downstream system with the expected behavior. For example, the positions of the cameras and/or further sensors can be optimized such that depth information can also be captured through stereo vision and types of objects in the environment of the vehicle can thus be classified more accurately.

However, the optimization goal can, for example, also include, alternatively or in combination, finding a configuration of cameras and/or further sensors that requires minimal hardware effort and for which the behavior of the downstream system still corresponds to the expected behavior.

For example, in the case of a system for monitoring regions, the cost expenditure depends decisively on the total number of required cameras and/or other sensors. The result of the optimization can thus, for example, be that the predetermined region can be covered with fewer cameras and/or other sensors if they are arranged in a particularly appropriate way.

A vehicle, a driving assistance system, a robot, a quality control system, a system for monitoring regions, and/or a system for medical imaging is thus selected particularly advantageously as a downstream system.

In a further, particularly advantageous embodiment of the present invention, at least one measured variable captured by means of a radar sensor, lidar sensor and/or ultrasonic sensor, and/or a processing product of such a measured variable is selected as a further physical measured variable. These additional measurement modalities have a particularly good potential to complement one another with camera images and, in particular, to fill gaps that one imaging modality has when observing certain locations from certain perspectives.

The measured value captured by means of the radar sensor, lidar sensor and/or ultrasonic sensor can, for example, in particular comprise
a measured position of a location from which a radar reflection, lidar reflection or ultrasonic reflection comes, and/or
a covariance of the radar measurement, lidar measurement or ultrasonic measurement, and/or
a velocity of the radar sensor, lidar sensor or ultrasonic sensor relative to the location from which the radar reflection, lidar reflection or ultrasonic reflection comes.

These are the variables that are in particular evaluated when monitoring the environment of vehicles and/or robots.

Thus, advantageously, according to an example embodiment of the present invention, at least one camera and/or at least one radar sensor, lidar sensor and/or ultrasonic sensor is carried by a vehicle or robot. However, not all sensors have to be mobile. In fact, stationary sensors, such as monitoring cameras installed at the location of the scene, can also make a complementary contribution, for example.

The information characterizing the perspective can, for example, in particular include a direction from a reference point of the vehicle and/or robot to the location viewed. This direction may, for example, be given in the form of one or more angles. Alternatively or in combination, the information characterizing the perspective can also include the position of the vehicle and/or robot. As explained above, one and the same location from one and the same perspective can, for example, be visible from a close position but obscured from a more distant position.

For example, the camera images and/or the at least one further physical measured variable can in particular be used to determine the position of the vehicle and/or robot. For example, the position can be ascertained by means of a simultaneous location and mapping (SLAM) method. In this way, the position can be ascertained more accurately than would be possible with a satellite-based navigation system. This is, for example, in particular true in interior spaces, for example, production halls, with poor satellite reception.

In a particularly advantageous embodiment of the present invention, the cost function includes a standard of a distance between a first vector of variables output by the neural network for at least one location and a second vector of measured variables corresponding thereto. In this way, the evaluations with respect to physically very different measurement modalities can be combined so that, for example, a poorer performance with respect to one measurement modality can be compensated by better performance with respect to other measurement modalities.

For example, different measurement modalities can in particular be weighted relative to one another in the cost function. This, for example, makes it in particular possible to compensate for the fact that different measurement modalities use different numbers of measured variables. For example, color information may be available in the form of intensity values for the three primary colors of red, green and blue, while a radar measurement can provide three spatial coordinates for a location of the radar reflection, a scalar covariance and additionally also a scalar velocity, i.e., a total of five variables. For example, the different variables provided by a radar measurement can also have different levels of significance in the context of the particular application.

The method can in particular be wholly or partially computer-implemented. The present invention therefore also relates to a computer program comprising machine-readable instructions that, when executed on one or more computers and/or compute instances, cause the computer(s) and/or compute instances to execute the described method of the present invention. In this sense, control devices for vehicles and embedded systems for technical devices, which are also capable of executing machine-readable instructions, are also to be regarded as computers. Compute instances can be virtual machines, containers or serverless execution environments, for example, which can be provided in a cloud in particular.

The present invention also relates to a machine-readable data carrier and/or to a download product comprising the computer program. A download product is a digital product that can be transmitted via a data network, i.e., can be downloaded by a user of the data network, and can, for example, be offered for immediate download in an online shop.

Furthermore, one or more computers and/or compute instances can be equipped with the computer program, with the machine-readable data carrier, or with the download product.

Further measures improving the present invention are explained in more detail below, together with the description of the preferred exemplary embodiments of the present invention, with reference to figures.

### BRIEF DESCRIPTION OF THE DRAWINGS

FIG. 1 shows an exemplary embodiment of the method 100 for training a neural network 1, according to the present invention.

FIG. 2 shows an illustration of the functionality of the method 100 for a three-dimensional scene, according to the present invention.

### DETAILED DESCRIPTION OF EXAMPLE EMBODIMENTS

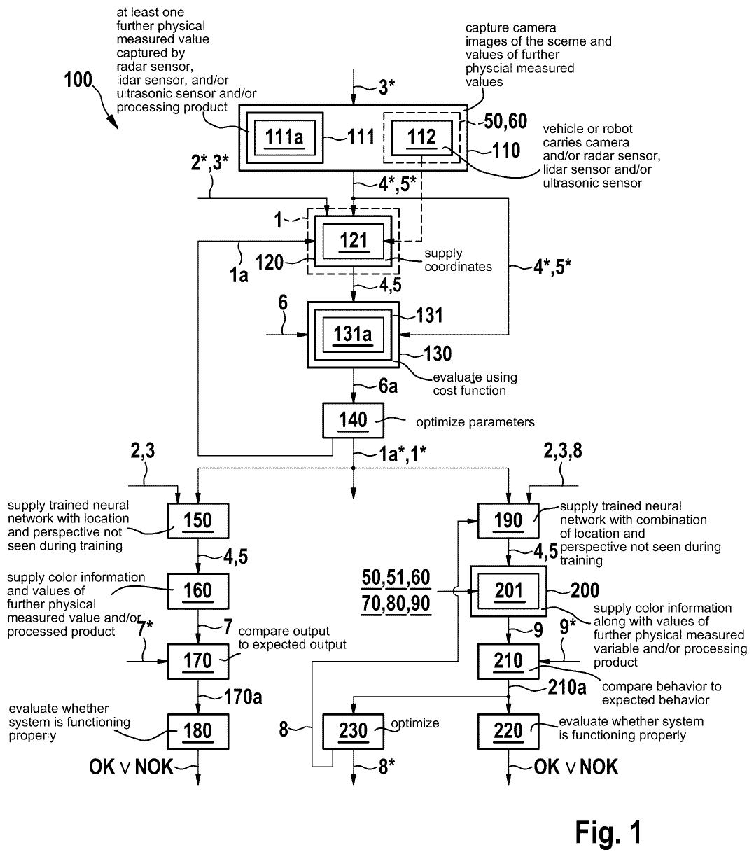

FIG. 1 is a schematic flow chart of an exemplary embodiment of the method 100 for training a neural network 1. The neural network 1 is designed, on the basis of coordinates of a location 2 in a scene and information about a perspective 3 from which the location is viewed, to predict color information 4 along with values of at least one further physical measured variable 5 that relate to this location.

In step 110, both camera images 4* of the scene and values of the further physical measured variable 5* are captured as training examples from a plurality of perspectives 3*.

According to block 111, at least one measured variable captured by means of a radar sensor, lidar sensor and/or ultrasonic sensor, and/or a processing product of such a measured variable can, for example, in particular be selected as a further physical measured variable 5.

According to block 111a, the measured value 5 captured by means of the radar sensor, lidar sensor and/or ultrasonic sensor can, for example, in particular comprise
a measured position of a location from which a radar reflection, lidar reflection or ultrasonic reflection comes, and/or
a covariance of the radar measurement, lidar measurement or ultrasonic measurement, and/or
a velocity of the radar sensor, lidar sensor or ultrasonic sensor relative to the location from which the radar reflection, lidar reflection or ultrasonic reflection comes.

According to block 112, at least one camera and/or at least one radar sensor, lidar sensor and/or ultrasonic sensor can be carried by a vehicle 50 or robot 60.

In step 120, coordinates of locations 2* at which color information 4 and/or values of the at least one further physical measured variable 5 can be captured from every perspective 3* are then supplied, together with information characterizing the perspective 3*, to the neural network 1.

According to block 121, the information characterizing the perspective 3* can, for example, in particular include
a direction from a reference point of the vehicle 50 and/or robot 60 to the location viewed, and/or
the position of the vehicle 50 and/or robot 60, provided that, according to block 112, at least one sensor, or at least one camera, is carried by the vehicle 50 and/or robot 60.

In step 130, a predetermined cost function 6 is used to evaluate the extent to which the color information 4 subsequently provided by the neural network 1 for these locations, and/or values of the at least one further physical measured variable 5 are consistent with the camera images 4* actually captured from the particular perspective 3*, and/or values of the at least one further measured variable 5*.

According to block 131, the cost function 6 can, for example, in particular include a standard of a distance between a first vector of variables output by the neural network for at least one location and a second vector of measured variables corresponding thereto.

According to block 131a, different measurement modalities can be weighted relative to one another in the cost function 6.

In step 140, parameters 1a characterizing the behavior of the neural network 1 are optimized with the aim of improving the evaluation 6a by the cost function 6 in the further processing of coordinates of locations 2* and perspectives 3*. The fully optimized state of the parameters is denoted by reference sign 1a* and characterizes the fully trained state 1* of the neural network 1.

The fully trained neural network 1* can be used in a variety of ways to create multimodal views, i.e., color information 4 combined with the values of further measured variables 5, of the scene used for training, from any perspectives 3, analogously to the generation of any view from a physical, three-dimensional diorama. FIG. 1 shows two exemplary applications.

In step 150, the trained neural network 1* can be supplied with at least one combination of a location 2 and a perspective 3 that was not seen during training.

In step 160, the color information 4 subsequently provided by the neural network 1* along with values of at least one further physical measured variable 5 and/or a processing product formed from these variables can be supplied to at least one system for the behavior planning of a vehicle 50 and/or robot 60.

In step 170, the output 7 of this behavior planning system can be compared to an expected output 7*.

In step 180, the result 170a of this comparison can be used to evaluate whether the behavior planning system is functioning properly (OK) or not (not OK=NOK).

In step 190, the trained neural network 1* can be supplied with at least one combination of a location 2 and a perspective 3 that was not seen during training and that represents a new configuration 8 of cameras and/or further sensors, i.e., a different configuration than the one used to capture the training examples.

In step 200, the color information 4 subsequently provided by the neural network 1* along with values of at least one further physical measured variable 5 and/or a processing product formed from these variables can be supplied to at least one downstream system.

A vehicle 50, a driving assistance system 51, a robot 60, a quality control system 70, a system 80 for monitoring regions, and/or a system 90 for medical imaging can, for example, in particular be selected as a downstream system.

In step 210, the behavior 9 of the downstream system that results from the control with the color information 4 and values of the further physical measured variable 5, or with the processing product formed therefrom, can be compared to an expected behavior 9*.

In step 220, the result 210a of this comparison can be used to evaluate whether the combination of the new configuration 8 of cameras and/or further sensors with the downstream system is functioning properly (OK) or not (not OK=NOK).

In step 230, the new configuration 8 of cameras and/or further sensors can be optimized for a predetermined optimization goal. For example, this optimization goal can in particular include improving the consistency of the behavior 9 of the downstream system with the expected behavior 9*.

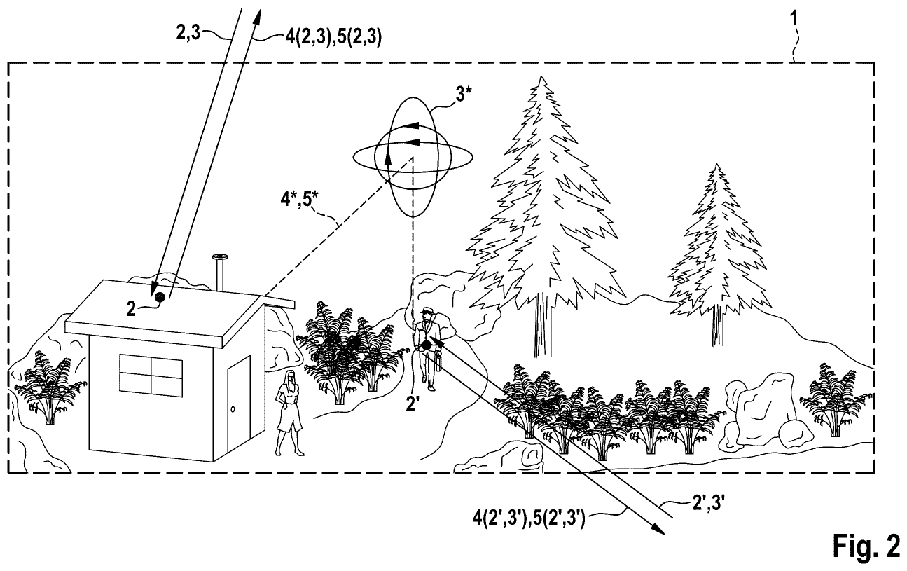

FIG. 2 illustrates, on the basis of an example, how the neural network 1 makes it possible to generate ever new multimodal views of one and the same scene.

For training the neural network 1, both camera images 4* of the scene and values of the further physical measured variable 5* are captured as training examples from a plurality of perspectives 3*. As explained above, the self-supervised training can then, for example, in particular be aimed at ensuring that the neural network 1 reproduces the information known from the capture by measurement technology.

After training the neural network 1, the neural network 1 can be queried for any combinations of locations 2 and perspectives 3 as to which color information 4 (2, 3) and which values of further measured variables 5 (2, 3) the location 2 shows when viewed from the perspective 3. In FIG. 2, this is shown for two exemplary combinations 2, 3 and 2′, 3′ of locations 2, 2′ and perspectives 3, 3′.

What is claimed is:

1. A method for training a neural network, which, based on coordinates of a location in a scene and information about a perspective from which the location is viewed, predicts color information along with values of at least one further physical measured variable that relate to the location, the method comprising the following steps:
capturing, from a plurality of perspectives, camera images of the scene, and values of the further physical measured variable, as training examples;
supplying coordinates of locations at which color information and/or values of the at least one further physical measured variable can be captured from every perspective, together with information characterizing the perspective, to the neural network;
evaluating, using a predetermined cost function, an extent to which color information subsequently provided by the neural network for the locations, and/or values of the at least one further physical measured variable, are consistent with the camera images actually captured from the perspective, and/or values of the at least one further measured variable;
optimizing parameters characterizing a behavior of the neural network, with an aim of improving the evaluation by the cost function in the further processing of coordinates of locations and perspectives.

2. The method according to claim 1, wherein at least one measured variable captured using: (i) a radar sensor, and/or (ii) a lidar sensor, and/or (iii) a ultrasonic sensor, and/or (iv) a processing product of a measured variable captured using a radar sensor, and/or a lidar sensor, and/or a ultrasonic sensor, is selected as a further physical measured variable.

3. The method according to claim 2, wherein the measured variable captured by using the radar sensor, and/or the lidar sensor and/or the ultrasonic sensor includes:
a measured position of a location from which a radar reflection or lidar reflection or ultrasonic reflection comes, and/or
a covariance of the radar measurement or lidar measurement or ultrasonic measurement, and/or
a velocity of the radar sensor or lidar sensor or ultrasonic sensor relative to a location from which a radar reflection or lidar reflection or ultrasonic reflection comes.

4. The method according to claim 1, wherein at least one camera and/or at least one radar sensor and/or at least one lidar sensor and/or at least one ultrasonic sensor is carried by a vehicle and/or robot.

5. The method according to claim 4, wherein the information characterizing the perspective includes:
a direction from a reference point of the vehicle and/or robot to the location viewed, and/or
a position of the vehicle and/or robot.

6. The method according to claim 5, wherein the camera images and/or the at least one further physical measured variable are used to determine the position of the vehicle and/or robot.

7. The method according to claim 1, wherein the cost function includes a standard of a distance between a first vector of variables output by the neural network for at least one location and a second vector of measured variables corresponding thereto.

8. The method according to claim 7, wherein different measurement modalities are weighted relative to one another in the cost function.

9. The method according to claim 1, wherein:
the trained neural network is supplied with at least one combination of a location and a perspective that was not seen during training,
the color information ubsequently provided by the neural network along with values of at least one further physical measured variable and/or a processing product formed from the at least one physical measured variable is supplied to at least one system for behavior planning of a vehicle and/or robot,
an output of the system for behavior planning is compared to an expected output, and
a result of the comparison is used to evaluate whether the system for behavior planning is functioning properly.

10. The method according to claim 1, wherein:
the trained neural network is supplied with at least one combination of a location and a perspective that was not seen during training and that represents a different configuration of cameras and/or further sensors than the one used to capture the training examples;
the color information subsequently provided by the neural network along with values of at least one further physical measured variable and/or a processing product formed from the phyical measured variable are supplied to at least one downstream system;
a resulting behavior of the downstream system is compared to an expected behavior; and
a result of the comparison is used to evaluate whether the combination of the different configuration of cameras and/or further sensors with the downstream system is functioning properly.

11. The method according to claim 10, wherein a vehicle and/or a driving assistance system and/or a robot and/or a quality control system and/or a system for monitoring regions and/or a system for medical imaging, is the downstream system.

12. The method according to claim 10, wherein the different configuration of cameras and/or further sensors is optimized for a predetermined optimization goal.

13. A non-transitory machine-readable data carrier on which is stored a computer program including machine-readable instructions for training a neural network, which, based on coordinates of a location in a scene and information about a perspective from which the location is viewed, predicts color information along with values of at least one further physical measured variable that relate to the location, the instructions, when executed by one or more computers and/or compute instances, cause the one or more computers and/or compute instances to perform the following steps:
capturing, from a plurality of perspectives, camera images of the scene, and values of the further physical measured variable, as training examples;
supplying coordinates of locations at which color information and/or values of the at least one further physical measured variable can be captured from every perspective, together with information characterizing the perspective, to the neural network;
evaluating, using a predetermined cost function, an extent to which color information subsequently provided by the neural network for the locations, and/or values of the at least one further physical measured variable, are consistent with the camera images actually captured from the perspective, and/or values of the at least one further measured variable;
optimizing parameters characterizing a behavior of the neural network, with an aim of improving the evaluation by the cost function in the further processing of coordinates of locations and perspectives.

14. One or more computers and/or compute instances equipped with a non-transitory machine-readable data carrier on which is stored a computer program including machine-readable instructions for training a neural network, which, based on coordinates of a location in a scene and information about a perspective from which the location is viewed, predicts color information along with values of at least one further physical measured variable that relate to the location, the instructions, when executed by the one or more computers and/or compute instances, cause the one or more computers and/or compute instances to perform the following steps:
capturing, from a plurality of perspectives, camera images of the scene, and values of the further physical measured variable, as training examples;
supplying coordinates of locations at which color information and/or values of the at least one further physical measured variable can be captured from every perspective, together with information characterizing the perspective, to the neural network;
evaluating, using a predetermined cost function, an extent to which color information subsequently provided by the neural network for the locations, and/or values of the at least one further physical measured variable, are consistent with the camera images actually captured from the perspective, and/or values of the at least one further measured variable;
optimizing parameters characterizing a behavior of the neural network, with an aim of improving the evaluation by the cost function in the further processing of coordinates of locations and perspectives.
